(19) United States
(12) Patent Application Publication
(10) Pub. No.: US 2020/0254844 A1
(43) Pub. Date: Aug. 13, 2020

(54) SEPARATOR FOR VEHICLE THERMAL MANAGEMENT SYSTEM

(71) Applicant: Ford Global Technologies, LLC, Dearborn, MI (US)

(72) Inventors: Enrique Lopez Hernandez, Toluca (MX); Mario Alberto Martinez Mendez, Royal Oak, MI (US)

(21) Appl. No.: 16/272,850

(22) Filed: Feb. 11, 2019

(51) Int. Cl. B60H 1/00; B01D 19/00; F25B 43/00

(52) U.S. Cl. CPC B60H 1/00278; B60H 1/00392; B60H 2001/00935; F25B 43/00; F25B 2400/23; B01D 19/0063

(57) ABSTRACT

A vehicle thermal management system has a separator including a first set of protuberances disposed within a cavity and four ports open to the cavity, a pump in fluid communication with a first of the four ports to control thermal management fluid delivery to the cavity, and a degas bottle in fluid communication with a second of the four ports. The protuberances and the four ports are arranged with one another such that a laminar flow of the thermal management fluid entering the cavity is obstructed and a portion of air of the thermal management fluid is separated and directed through the second of the four ports to the degas bottle.

### TECHNICAL FIELD

The present disclosure relates to an apparatus and system for separating air from thermal management fluid within a vehicle thermal management system.

### BACKGROUND

Extended drive range technology for electrified vehicles, such as battery electric vehicles (“BEVs”) and plug in hybrid vehicles (“PHEVs”), is continuously improving. Achieving these increased ranges, however, often requires systems of electrified vehicles to have higher power outputs and associated thermal management systems with increased capacities in comparison to previous BEVs and PHEVs. A separation of air from thermal management fluid flowing within the thermal management system is one example of a challenge present in designing the thermal management systems. Future hybrid and electrified vehicles may include additional components in comparison to past hybrid and electrified vehicles that need to be cooled with a system that efficiently separates air from the thermal management fluid.

### SUMMARY

A vehicle thermal management system has a separator including four ports and a body defining a cavity, a pump in fluid communication with the separator to move thermal management fluid therethrough, and one or more first protuberances disposed at a cavity lower surface adjacent an opening to one of the four ports, and arranged relative to the opening to disrupt a flow of the thermal management fluid entering the cavity via one of the four ports.

An orthogonal separator for a thermal management system includes a central portion defining a cavity, two inlets and two outlets extending from the central portion, each open to the cavity and each in fluid communication with a thermal loop of a vehicle thermal management system, and a first set of protuberances disposed within the cavity. The two inlets are located opposite one another and define a first central axis, and each of the two inlets defines a cross-sectional area of which the central axis extends therethrough. Each of the first set of protuberances is disposed within the cavity at a location intersecting the central axis and each of the first set of protuberances is spaced from one of the two inlets a predetermined distance such that air bubbles of thermal management fluid traveling through the one of the two inlets stick to at least one of the first set of protuberances and a de-aerated portion of the thermal management fluid exits the cavity through one of the two outlets.

A vehicle thermal management system has a separator including a first set of protuberances disposed within a cavity and four ports open to the cavity, a pump in fluid communication with a first of the four ports to control thermal management fluid delivery to the cavity, and a degas bottle in fluid communication with a second of the four ports. The protuberances and the four ports are arranged with one another such that a laminar flow of the thermal management fluid entering the cavity is obstructed and a portion of air of the thermal management fluid is separated and directed through the second of the four ports to the degas bottle.

### BRIEF DESCRIPTION OF THE DRAWINGS

FIG. 1 is a schematic diagram illustrating an example of an electrified vehicle.

FIG. 2A is a schematic diagram illustrating an example of a portion of a thermal management system for a vehicle.

FIG. 2B is a schematic diagram illustrating an example of a portion of a thermal management system for a vehicle.

FIG. 3 is a perspective view of an example of a separator for use in a vehicle thermal management system.

FIG. 4 is a front view of the separator of FIG. 3 including schematic representation of thermal management fluid flow to and from the separator.

FIG. 5A is a perspective view, in partial cross-section, of an example of a separator for use in a vehicle thermal management system.

FIG. 5B is a front view of the separator of FIG. 5A

FIG. 5C is a front view of another example of a separator for use in a vehicle thermal management system.

FIG. 6A is a top plan view, in cross-section, of the separator of FIGS. 3, 4, 5A, and 5B.

FIG. 6B is a fragmentary front view of a portion of the separator of FIGS. 2, 4, 5A, and 5B.

FIG. 6C is a fragmentary front view of a portion of the separator of FIG. 5C.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

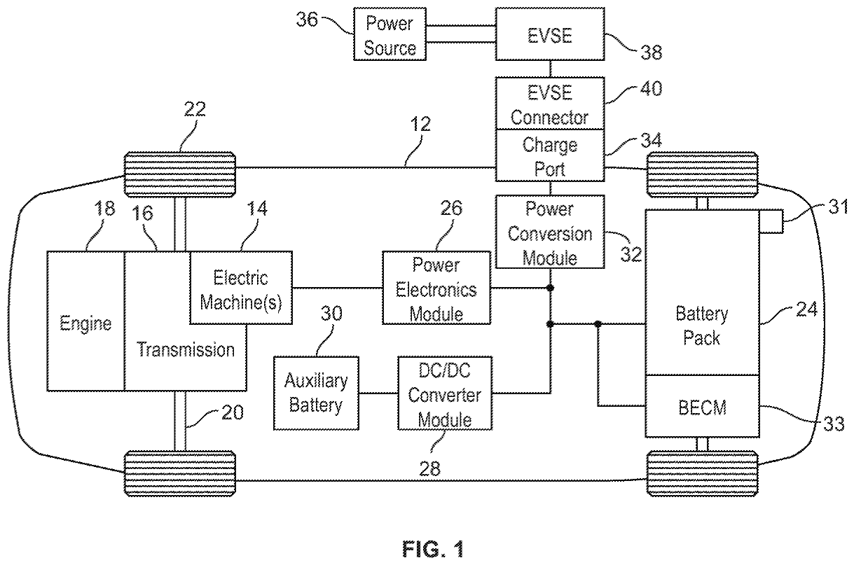

FIG. 1 is a schematic representation of an example of an electrified vehicle. In this example, the electrified vehicle is a plug-in hybrid electric vehicle (PHEV) referred to as a vehicle 12 herein. The vehicle 12 may include one or more electric machines 14 mechanically connected to a hybrid transmission 16. Each of the electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to wheels 22. The electric machines 14 may provide propulsion and deceleration capability when the engine 18 is turned on or off. The electric machines 14 may also operate as generators and provide filet economy benefits by recovering energy that would normally be lost as heat in, for example, a friction braking system.

A traction battery 24 stores energy that may be used by the electric machines 14. The traction battery 24 may provide a high voltage DC output from one or more battery cell arrays, sometimes referred to as battery cell stacks, within the traction battery 24. Each of the battery cell arrays may include one or more battery cells. The traction battery 24 is electrically connected to one or more power electronics modules 26 through one or more contactors (not shown). The one or more contactors isolate the traction battery 24 from other components when opened and connects the traction battery 24 to other components when closed. The power electronics module 26 is also electrically connected to the electric machines 14 and provides the ability to bi-directionally transfer electrical energy between the traction battery 24 and the electric machines 14. For example, a typical traction battery 24 may provide a DC voltage while the electric machines 14 may require a three-phase AC voltage to function. The power electronics module 26 may convert the DC voltage to a three-phase AC voltage as required by the electric machines 14 or other electrical components. In a regenerative mode, the power electronics module 26 may convert the three-phase AC voltage from the electric machines 14 acting as generators to the DC voltage required by the traction battery 24. Portions of the description herein are equally applicable to a pure electric vehicle.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. In a typical vehicle, the low-voltage systems are electrically connected to an auxiliary battery 30 (e.g., a twelve-volt battery).

A battery electrical control module (BECM) 33 may be in communication with the traction battery 24. The BECM 33 may act as a controller for the traction battery 24 and may also include an electronic monitoring system that manages temperature and a charge state of each battery cell of the traction battery 24. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36 such as a source in communication with an electrical outlet. The external power source 36 may be electrically connected to an electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The charge connector 40 may have pins that mate with corresponding recesses of the charge port 34.

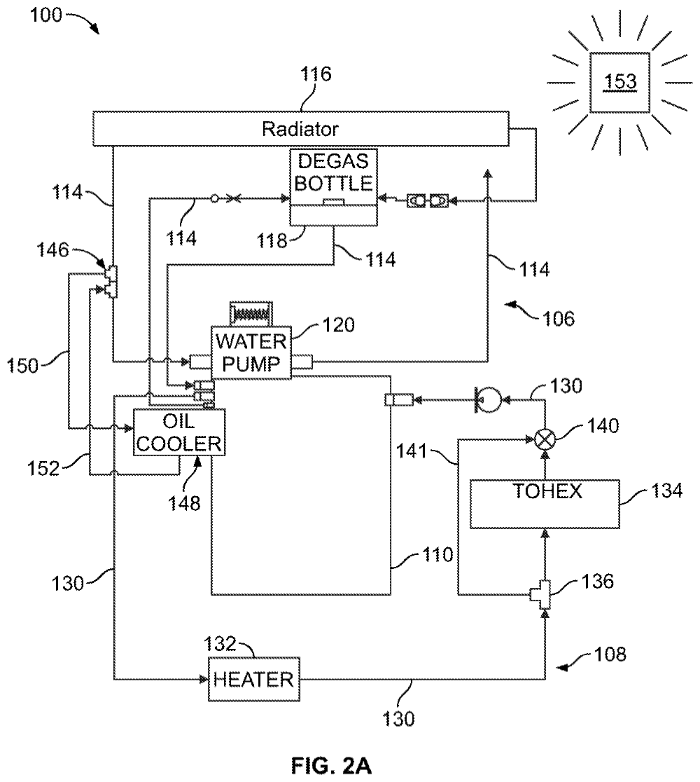

FIG. 2A is a schematic diagram illustrating an example of a portion of a vehicle thermal management system for an internal combustion engine, referred to generally herein as a thermal management system 100. The thermal management system 100 may assist in managing thermal conditions of, for example, a vehicle engine 110. The thermal management system 100 includes a first thermal loop 106 and a second thermal loop 108.

The first thermal loop 106 includes a first system of conduits 114 to distribute thermal management fluid throughout the first thermal loop 106. For example, each conduit of the first system of conduits 114 is arranged with one another to distribute the thermal management fluid between a radiator 116, a degas bottle 118, and a water pump 120. Examples of the thermal management fluid include coolant and refrigerant. The radiator 116 may operate to heat and/or cool the thermal management fluid flowing within the first thermal loop 106. The degas bottle 118 may operate to de-aerate the thermal management fluid traveling therethrough. The water pump 120 may operate to assist in removing heat produced by the engine 110 by drawing heat therefrom.

The second thermal loop 108 includes a second system of conduits 130 to distribute thermal management fluid throughout the second thermal loop 108. For example, each conduit of the second system of conduits 130 is arranged with one another to distribute the thermal management fluid between the engine 110, a heater 132, and a heat exchanger (TOHEX) 134. A bypass valve 136 may selectively divert the thermal management fluid around the TOHEX 134 upon receipt of a command to do the same. In one example, a valve 140 may be selectively opened to draw thermal management fluid along a bypass line 141 between the bypass valve 136 and the valve 140.

A transfer mechanism 146 (e.g., a body defining four ports, some of which may restrict flow therethrough) of the first thermal loop 106 and an oil cooler 148 of the second thermal loop 108 may operate with one another to selectively exchange thermal management fluid between the first thermal loop 106 and the second thermal loop 108. For example, a first line 150 may extend from the transfer mechanism 146 to the oil cooler 148 and deliver thermal management fluid from the first thermal loop 106 to the second thermal loop 108 based on received instructions. A second line 152 may extend from the oil cooler 148 to the transfer mechanism 146 and deliver thermal management fluid from the second thermal loop 108 to the first thermal loop 106. A controller 153 may be in wired or wireless communication with components of the thermal management system 100, such as the transfer mechanism 146 and the oil cooler 148, to direct operation thereof and receive information signals therefrom.

FIG. 2B is a schematic diagram illustrating an example of a portion of a vehicle thermal management system for a vehicle electrical system, referred to generally herein as a thermal management system 200. The thermal management system 200 may assist in managing thermal conditions of an electrical system including a high-voltage battery 204. The thermal management system 200 includes a third thermal loop 206 and a fourth thermal loop 208. The thermal management system 200 and the thermal management system 100 may be included within a same vehicle to operate with one another to manage thermal conditions of systems and components of the same vehicle.

The third thermal loop 206 includes a third system of conduits 214 to distribute thermal management fluid throughout the third thermal loop 206. Examples of the thermal management fluid include coolant and refrigerant. Each conduit of the third system of conduits 214 is arranged with one another to distribute the thermal management fluid between a radiator 216, a three-way valve 217, a DC/DC converter 218, a pump 219, and an inverter system controller (ISC) 220. The radiator 216 may operate to heat and/or cool the thermal management fluid flowing within the third thermal loop 206. The three-way valve 217 may operate to selectively receive thermal management fluid via a line 215 after being de-aerated by a degas bottle 226.

The fourth thermal loop 208 includes a fourth system of conduits 230 to distribute thermal management fluid throughout the fourth thermal loop 208. Each conduit of the fourth system of conduits 230 is arranged with one another to distribute the thermal management fluid between the high-voltage battery 204, a low temperature radiator 234, a battery chiller 236, and a heat exchanger 238. The high-voltage battery 204 may operate to provide power to components of the vehicle. The low temperature radiator 234 may operate to assist in managing thermal conditions of the fourth thermal loop 208. The battery chiller 236 may operate to assist in managing thermal conditions of the high-voltage battery 204. The heat exchanger 238 may operate to assist in managing thermal conditions of the fourth thermal loop 208.

The third thermal loop 206 and the fourth thermal loop 208 may operate with one another to manage thermal conditions of electrical components of the thermal management system 200 including the high-voltage battery 204. A separator may be included in the thermal management system 100 and/or the thermal management system 200 to assist in separating air from thermal management fluid as further described herein.

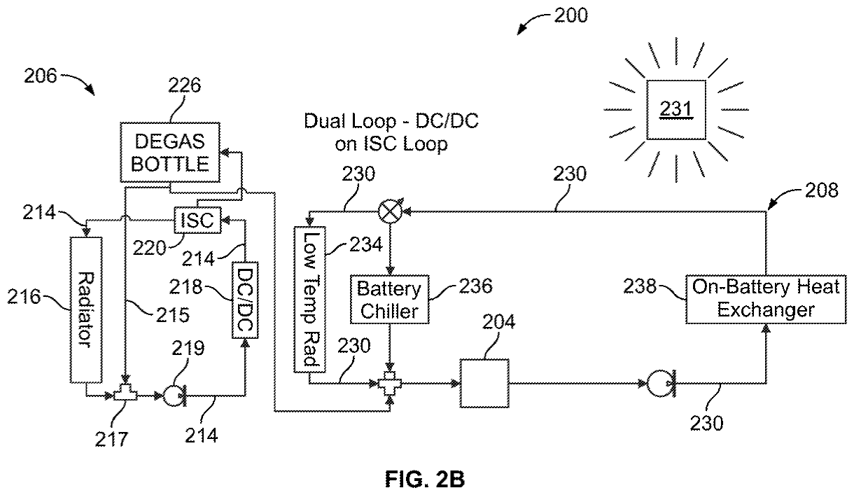

FIG. 3 is a perspective view of an example of a separator 300 for use in a thermal management system, such as the thermal management system 100 and/or the thermal management system 200. The separator 300 may operate to separate air from thermal management fluid flowing through the thermal management system.

The separator 300 may include a first port 304, a second port 306, a third port 308, and a fourth port 310. Each of the ports may be defined by a cylindrical tube though it is contemplated that other shapes may be used for each tube. Each of the ports may operate as an inlet or an outlet and may be in fluid communication with a chamber defined by a central portion 314 of the separator 300. The first port 304 and the third port 308 may be arranged with one another to define a first central axis 315. The second port 306 and the fourth port 310 may be arranged with one another to define a second central axis 317. The ports may be arranged with one another such that the first central axis 315 and the second central axis 317 are oriented perpendicular relative to one another.

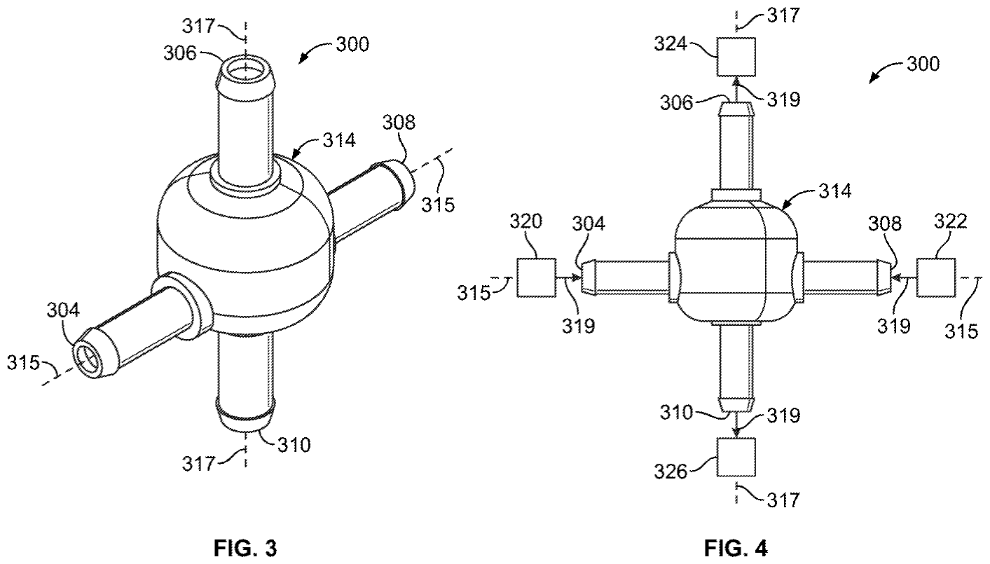

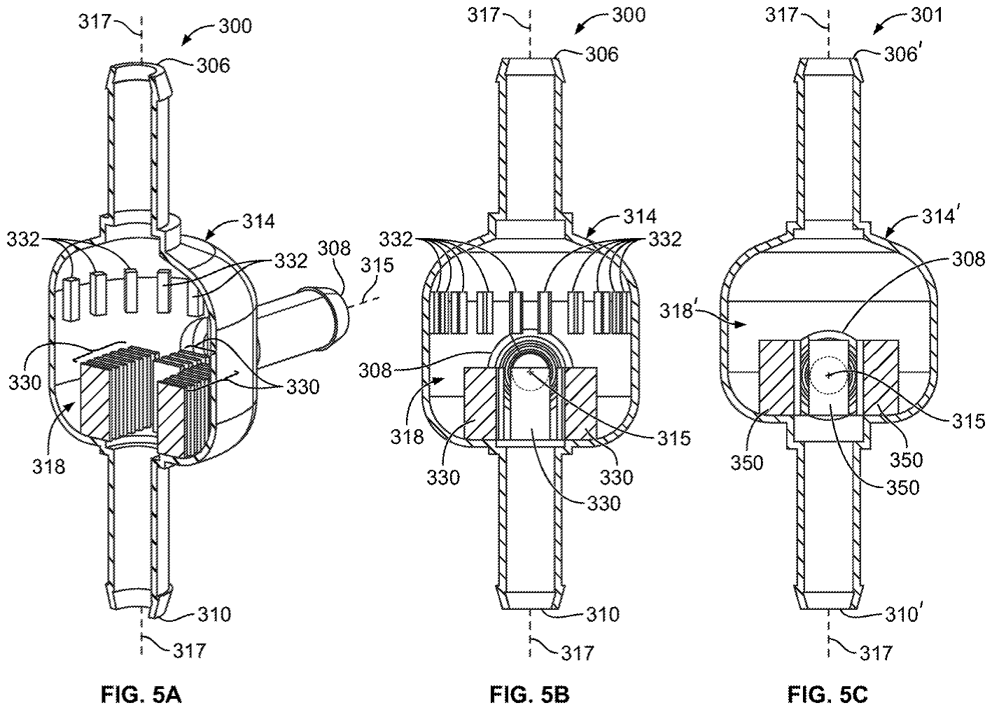

For example, the ports may be arranged to define a substantially orthogonal relationship between the central axes as shown in FIGS. 3 and 4. The separator 300 may be arranged within a thermal management system such that two of the ports operate as inlets and two of the ports operate as outlets for thermal management fluid to flow therethrough. The central portion 314 of the separator 300 may define a cavity 318 (best shown in FIGS. 5A through 5C). The cavity 318 may define a volume substantially equal to 125 mL.

FIG. 4 is a front view of the separator 300 and includes a schematic representation of thermal management fluid flow to and from the separator 300 as represented by arrows 319. For example, the first port 304 may receive thermal management fluid from a first component 320 of the thermal management system and the third port 308 may receive thermal management fluid from a second component 322 of the thermal management system. The thermal management fluid may exit the separator 300 en route to a degas bottle 324 via the second port 306 and the thermal management fluid may exit separator 300 en route to a pump 326 via the fourth port 310. The pump 326 may operate to assist in controlling a flow of the thermal management fluid through the separator 300. Examples of the first component 320 include the ISC 220. Examples of the second component 322 include a battery heat exchanger.

FIGS. 5A through 5C are partial cross-sectional views of embodiments of the separator 300 illustrating examples of inner components. The separator 300 may include protuberances or turbulators within the central portion 314 to assist in obstructing flow of and creating turbulence within thermal management fluid flowing through the central portion 314. For example, the protuberances may be arranged within the central portion 314 to disrupt a laminar flow of thermal management fluid traveling therethrough and may also increase a Reynolds number of the thermal management fluid. Disrupting the laminar flow and increasing the thermal management fluid Reynolds number assists in promoting a separation of it from the thereat management fluid.

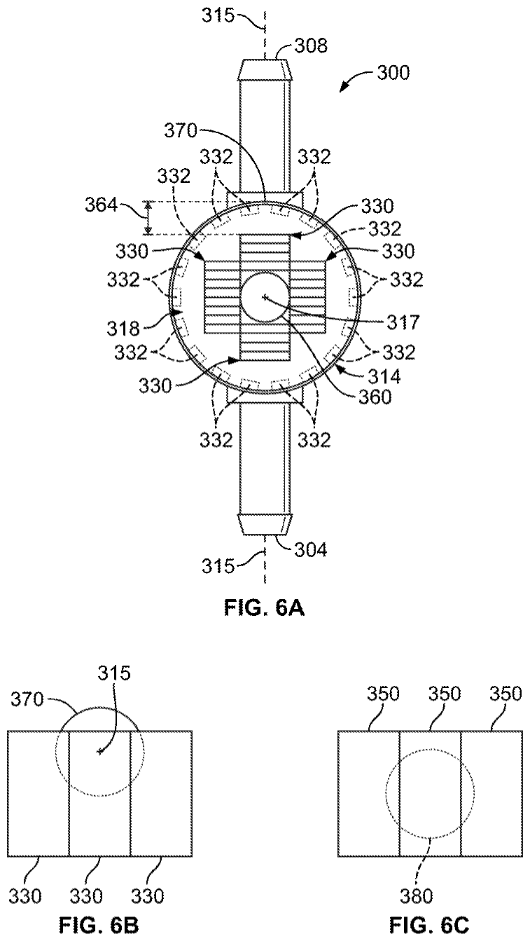

As shown in FIGS. 5A and 5B, the separator 300 may include a first set of protuberances 330 and/or a second set of protuberances 332. Each of the first set of protuberances 330 may be disposed at a lower interior surface of the central portion 314 within the cavity 318. Each of the first set of protuberances 330 may be disposed about an opening to the fourth port 310 (best shown in FIGS. 5A and 6A). Each of the second set of protuberances 332 may be disposed at an upper interior surface of the central portion 314 within the cavity 318.

Various shapes are available for the protuberances of the separator 300. Each of the first set of protuberances 330 and each of the second set of protuberances 332 may define a rectangular shape as shown in FIGS. 5A through 6C, though it is contemplated that each of the protuberances may define other shapes such as triangular, curved, etc. The protuberances may be arranged with one another within the central portion 314 such that air bubbles of the thermal management fluid flowing into the cavity 318 stick to a respective protuberance and then rise to the second port 306 once a respective air bubble defines a sufficient volume.

FIG. 5C illustrates an alternative embodiment of the separator 300, referred to generally as a separator 301 herein. Components of the separator 301 that are similar or the same as components of the separator 300 are numbered similar or the same. The separator 301 includes a third set of protuberances 350. Each protuberance of the third set of protuberances 350 may be disposed at a lower interior surface of a central portion 314′ within a cavity 318′ of the separator 301. Each of the third set of protuberances 350 may be disposed about an opening from the cavity 318 to a fourth port 310′. Various shapes are available for each protuberance of the third set of protuberances 350. In this example, each protuberance of the third set of protuberances 350 defines a rectangular shape though it is contemplated that other shapes may be used based on performance metrics.

The protuberances of the third set of protuberances 350 may be arranged with one another within the central portion 314′ such that air bubbles of the thermal management fluid stick to one of the third set of protuberances 350. In one example, the third set of protuberances 350 may be arranged upon a lower interior surface of the central portion 314 such that air bubbles of the thermal management fluid flowing into the cavity 318′ stick to a respective protuberance and then rise to a second port 306′ once a respective air bubble defines a sufficient volume.

FIGS. 6A and 6B illustrate further detail of the separator 300. FIG. 6A is a top plan view, in cross-section, of a portion of the separator 300 illustrating an example of locations of the first set of protuberances 330 and the second set of protuberances 332. FIG. 6B is a fragmentary front view of a portion of the separator 300 illustrating an example of a relationship between the locations of the first set of protuberances 330 and an opening 370 to the cavity 318.

As mentioned above, the separator 300 may include protuberances disposed within the cavity 318, such as the first set of protuberances 330 and the second set of protuberances 332. Each protuberance of the first set of protuberances 330 may be arranged in stacks adjacent an opening 360. Each protuberance of the second set of protuberances 332 (shown in broken lines in FIG. 6A) may be spaced equidistant from one another and located at an upper portion of an interior surface of the cavity 318. The opening 360 may be defined at a location in which one of the ports of the separator 300, such as the fourth port 310, opens to the cavity 318.

One protuberance of the first set of protuberances 330 may be spaced a distance 364 from the opening 370 at a location in which the third port 308 opens to the cavity 318. The distance 364 may be selected based on desired thermal management fluid flow disruption, and determined via testing or simulation for example. The thermal management fluid flow disruption increases as the distance 364 decreases in length. In one example, the first set of protuberances 330 may be arranged with the opening 370 such that substantially sixty percent of the thermal management fluid traveling through the opening 370 is obstructed (best shown in FIG. 6B).

FIG. 6C is a fragmentary front view of a portion of the separator 301. In this example, the third set of protuberances 350 may be arranged with an opening 380 such that substantially one hundred percent of the thermal management fluid traveling through the opening 380 is obstructed. A cavity of the separator 301 may define a volume substantially equal to 120 mL.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle thermal management system comprising:
a separator including four ports and a body defining a cavity;
a pump in fluid communication with the separator to move thermal management fluid therethrough; and
one or more first protuberances disposed at a cavity lower surface adjacent an opening to one of the four ports, and arranged relative to the opening to disrupt flow of the thermal management fluid entering the cavity via one of the four ports.

2. The system of claim 1, wherein the cavity defines a volume substantially equal to between 120 mL and 125 mL.

3. The system of claim 1, wherein the four ports are arranged relative to one another to define an orthogonal separator.

4. The system of claim 1 further comprising a second set of protuberances disposed at a cavity surface and arranged relative to the opening to further disrupt the flow.

5. The system of claim 1, wherein the opening defines a flow cross-section, and wherein at least one of the one or more first protuberances is arranged relative to the one of the four ports such that approximately sixty percent of the thermal management fluid entering the cavity and crossing the flow cross-section is disrupted.

6. The system of claim 1, wherein the opening defines a flow cross-section, and wherein at least one of the one or more first protuberances is arranged relative to the one of the four ports such that approximately one hundred percent of the thermal management fluid entering the cavity and crossing the flow cross-section is disrupted.

7. An orthogonal separator for a thermal management system comprising:
a central portion defining a cavity;
two inlets and two outlets extending from the central portion, each open to the cavity and each in fluid communication with a thermal loop of a vehicle thermal management system; and
a first set of protuberances disposed within the cavity, wherein the two inlets are located opposite one another and define a first central axis and each of the two inlets defines a cross-sectional area of which the central axis extends therethrough, wherein each of the first set of protuberances is disposed within the cavity at a location intersecting the central axis and each of the first set of protuberances is spaced from one of the two inlets a predetermined distance such that air bubbles of thermal management fluid traveling through the one of the two inlets stick to at least one of the first set of protuberances and a de-aerated portion of the thermal management fluid exits the cavity through one of the two outlets.

8. The separator of claim 7, wherein the two outlets are arranged with one another to define a second central axis, and wherein the inlets and outlets are arranged with one another such that the first central axis and the second central axis are oriented perpendicular to one another.

9. The separator of claim 7 further comprising a second set of protuberances, wherein each protuberance of the second set of protuberances is disposed at an upper inner portion of the cavity.

10. The separator of claim 7 further comprising a second set of protuberances, wherein each protuberance of the second set of protuberances is disposed at an upper inner portion of the cavity and spaced equidistantly from one another.

11. The separator of claim 7, wherein at least one of the first set of protuberances is arranged with one of the two inlets such that sixty to one hundred percent of thermal management fluid flow entering the cavity is obstructed.

12. A vehicle thermal management system comprising:
a separator including a first set of protuberances disposed within a cavity and four ports open to the cavity;
a pump in fluid communication with a first of the four ports to control thermal management fluid delivery to the cavity; and
a degas bottle in fluid communication with a second of the four ports, wherein the protuberances and the four ports are arranged with one another such that a laminar flow of the thermal management fluid entering the cavity is obstructed and a portion of air of the thermal management fluid is separated and directed through the second of the four ports to the degas bottle.

13. The system of claim 12 further comprising a second set of protuberances disposed at an upper portion of a surface within the cavity.

14. The system of claim 12, wherein the four ports are arranged with one another to define an orthogonal relationship.

15. The system of claim 12, wherein at least one of the first set of protuberances is located within the cavity to disrupt substantially sixty percent of flow of the thermal management fluid entering the cavity.

16. The system of claim 12, wherein at least one of the first set of protuberances is located within the cavity to disrupt substantially one hundred percent of flow of the thermal management fluid entering the cavity.
